(19) United States
(12) Patent Application Publication
(10) Pub. No.: US 2018/0237347 A1
(43) Pub. Date: Aug. 23, 2018

(54) SILICON NITRIDE SINTERED BODY WITH HIGH THERMAL CONDUCTIVITY AND METHOD FOR MANUFACTURING SAME

(71) Applicants: KOREA ADVANCED INSTITUTE OF SCIENCE AND TECHNOLOGY, Daejon (KR); KCC CORPORATION, Seoul (KR)

(72) Inventors: Do Kyung KIM, Daejeon (KR); Hyun Min LEE, Daejeon (KR); In Sig SEOG, Gyeonggi-do (KR); Eun Bok LEE, Seoul (KR)

(73) Assignees: KOREA ADVANCED INSTITUTE OF SCIENCE AND TECHNOLOGY, Daejon (KR); KCC Corporation, Seoul (KR)

(21) Appl. No.: 15/753,500

(22) PCT Filed: Aug. 17, 2016
(86) PCT No.: PCT/KR2016/009021

§ 371 Date: Feb. 19, 2018

(30) Foreign Application Priority Data
Aug. 17, 2015 (KR) 10-2015-0115551

(51) Int. Cl. C04B 35/593; C04B 35/645

(52) U.S. Cl. CPC C04B 35/5935; C04B 2235/96; C04B 35/645

(57) ABSTRACT

Embodiments relate to a method for manufacturing a silicon nitride sintered body with high thermal conductivity, which includes the steps of: a) obtaining a slurry by mixing a silicon nitride powder and a non-oxide based sintering aid; b) obtaining a mixed powder by drying the slurry; c) forming a compact by pressurizing the mixed powder; and d) sintering the compact.

### CROSS REFERENCE TO RELATED APPLICATIONS

This application claims the benefit of and priority to PCT/KR2016/009021, filed on Aug. 17, 2016, entitled (translation), “SILICON NITRIDE SINTERED BODY WITH HIGH THERMAL CONDUCTIVITY AND METHOD FOR MANUFACTURING SAME,” which claims the benefit of and priority to Korean Patent Application No. 10-2015-0115551, filed on Aug. 17, 2015, each of which is hereby incorporated by reference in their entirety into this application.

### BACKGROUND

### Field

Embodiments relate to a silicon nitride sintered body with high thermal conductivity and a method for manufacturing the same, and particularly, to a silicon nitride sintered body manufactured using a non-oxide-based sintering aid.

### Description of Related Art

As materials for a ceramic substrate, aluminum oxide (Al₂O₃), aluminum nitride (AlN), silicon carbide (SiC), silicon nitride (Si₃N₄), and the like have been commonly used. Aluminum oxide (Al₂O₃) has been mainly produced industrially due to its low production costs, but its low thermal conductivity and mechanical properties make it unsuitable for use in highly-integrated and high-performance circuits that have been recently developed. Also, aluminum nitride (AlN), which is an insulator having high thermal conductivity, has been widely used as a heat dissipation plate or a substrate for a highly integrated semiconductor device, but has a problem of a short lifespan due to degradation of thermal stability and mechanical properties.

Research is being actively conducted on a method of improving thermal conductivity of silicon nitride (Si₃N₄) having excellent mechanical properties. Silicon nitride is a ceramic which is difficult to sinter and has been commonly used in combination with alumina (Al₂O₃), zirconia (ZrO₂), or yttria (Y₂O₃) as a sintering aid to manufacture a high-density sintered body as disclosed in Japanese Unexamined Patent Application Publication No. 2005-225744.

In Japanese Laid-Open Patent No. 3476504, the use of a rare earth metal oxide as a sintering aid is disclosed.

However, when a common sintering aid is used as described above, a large amount of a secondary phase remains or the content of oxygen in a material is high, and thus thermal conductivity may be decreased due to defects caused by the high oxygen content.

### SUMMARY

Embodiments provide a silicon nitride sintered body manufactured by using a non-oxide-based sintering aid capable of minimizing the concentration of oxygen introduced into a sintered body, and a method for manufacturing the same.

According to an embodiment, there is provided a method for manufacturing a silicon nitride sintered body with high thermal conductivity, which includes the steps of: obtaining a slurry by mixing a silicon nitride powder and a non-oxide-based sintering aid; obtaining a mixed powder by drying the slurry; forming a compact by pressurizing the mixed powder; and sintering the compact.

According to at least one embodiment, the silicon nitride powder may be thermally pretreated at 1,400 to 1,600° C. under a nitrogen or argon atmosphere for 1 to 15 hours to reduce defects present in the powder.

According to at least one embodiment, the thermally pretreated silicon nitride powder may have oxygen and carbon contents of less than 1 wt % and an average particle diameter of 0.5 to 0.8 μm.

According to at least one embodiment, the non-oxide-based sintering aid may be a rare earth fluoride which may be volatilized when being sintered, and preferably is one or more selected from the group consisting of YF₃, YbF₃, LaF₃, NdF₃, GdF₃ and ErF₃.

According to at least one embodiment, the non-oxide-based sintering aid may be a magnesium silicide-based compound which may be volatilized when being sintered, and preferably is one or more selected from the group consisting of MgSiN₂ and Mg₂Si.

According to at least one embodiment, the non-oxide-based sintering aid may be included at a content of 0.1 to 10 wt %, preferably 0.5 to 5 wt % based on a total weight of the silicon nitride powder and the non-oxide-based sintering aid.

According to at least one embodiment, the step of forming the compact may be performed through cold isostatic pressing under a pressure condition of 100 to 400 MPa.

According to at least one embodiment, the step of sintering the compact may be performed by applying a pressure of 10 to 50 MPa under a nitrogen atmosphere at 1,700 to 1,800° C. for 1 to 20 hours.

According to at least one embodiment, the method may further include the step of thermally post-treating the sintered body at 1,800 to 1,850° C. for 3 to 10 hours for purification.

In addition, according to another embodiment, there is provided a silicon nitride sintered body with high thermal conductivity which has a bending strength of 660 to 870 MPa and a thermal conductivity of 70 W/mK or more.

Embodiments provide non-obvious advantages over the conventional art. For example, the silicon nitride (Si₃N₄) sintered body has a high mechanical strength of about 660 to 870 MPa and a high thermal conductivity of 70 W/mK or more.

The silicon nitride sintered body with high thermal conductivity according to various embodiments also has excellent thermal and mechanical properties as well as high thermal conductivity, and thus can be used for various purposes such as materials for a PCB substrate, heat dissipation plates, mechanical components and the like.

### BRIEF DESCRIPTION OF DRAWINGS

FIG. 1 is a flowchart of a process of manufacturing a silicon nitride sintered body with high thermal conductivity according to an embodiment.

FIG. 2 shows reference images for describing Experimental Example 1 of an embodiment.

FIG. 3 shows reference images for describing Experimental Example 3 of an embodiment.

FIG. 4 shows reference images for describing Experimental Example 5 of an embodiment.

FIG. 5 shows reference images for describing Experimental Example 6 of an embodiment.

### DETAILED DESCRIPTION

Hereinafter, exemplary embodiments will be described with reference to the accompanying drawings. Embodiments disclosed are intended to illustrate and not limit the technical spirit of the invention. Since the illustrated drawings magnify only essential principal elements and omit auxiliary elements for the purpose of clarity of the invention, the embodiments should not be interpreted only based on the drawings.

In order to obtain a silicon nitride sintered body with high thermal conductivity, a non-oxide-based sintering aid capable of minimizing the concentration (content) of oxygen in a sintered body is used to manufacture the sintered body.

In addition, in order to obtain a silicon nitride sintered body with high thermal conductivity, a silicon nitride ingredient powder in which defects present therein are effectively controlled is used to manufacture the sintered body.

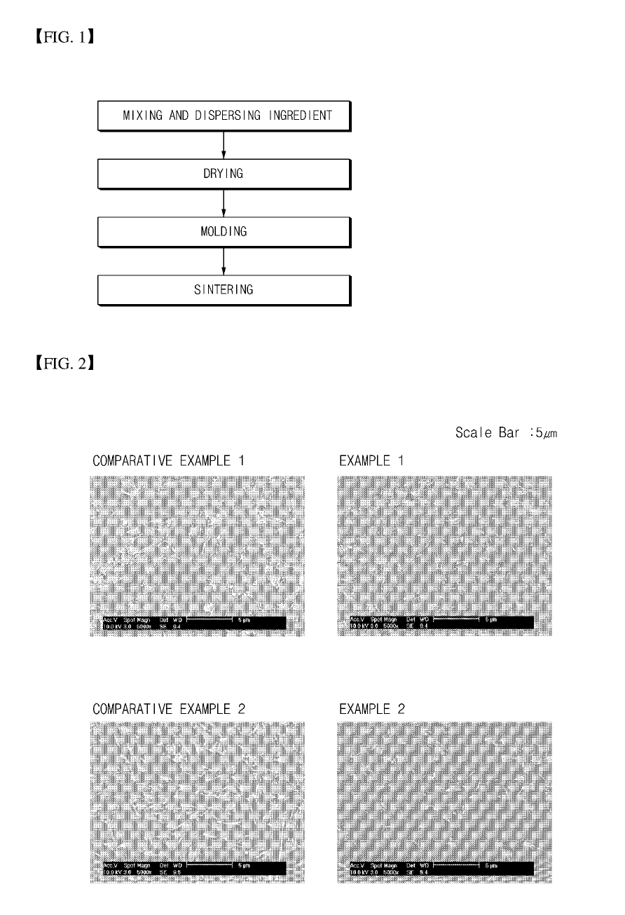

FIG. 1 is a flowchart of a manufacturing process according to an embodiment. According to at least one embodiment, a method for manufacturing a silicon nitride sintered body includes the steps of: obtaining a slurry by mixing a silicon nitride powder and a non-oxide-based sintering aid; obtaining a mixed powder by drying the slurry; forming a compact by pressurizing the mixed powder; and sintering the compact.

As the silicon nitride ingredient powder, a commercially available powder may be used as is or a commercially available powder may be thermally pretreated at 1,400 to 1,600° C. under a nitrogen or argon atmosphere for 1 to 15 hours for use. According to at least one embodiment, the silicon nitride powder may be thermally pretreated to reduce defects present in the silicon nitride powder, and a sintered body may be manufactured using the silicon nitride powder to obtain a sintered body with high thermal conductivity. An oxygen content of a silicon nitride powder which is not thermally pretreated is 1.27 wt %, and may be controlled to less than 1 wt % by thermally treating the silicon nitride power. When an oxygen content is controlled to less than 1 wt % as described above, a silicon vacancy in the silicon nitride powder is minimized, and thus thermal conductivity of a sintered body may be increased. In this case, a carbon content of the thermally pretreated silicon nitride powder may be less than 1 wt %. Also, such a silicon nitride powder may have an average particle diameter of 0.5 to 0.8 μm.

According to at least one embodiment, the non-oxide-based sintering aid is used to minimize the concentration of oxygen in a sintered body. As the non-oxide-based sintering aid, a rare earth fluoride, a magnesium silicide-based compound, or a mixture thereof may be used. That is, in accordance with at least one embodiment, a rare earth fluoride or a magnesium silicide-based compound is used instead of a rare earth oxide or a magnesium oxide conventionally used in the manufacture of a silicon nitride sintered body.

According to at least one embodiment, the rare earth fluoride may be one or more selected from the group consisting of YF₃, YbF₃, LaF₃, NdF₃, GdF₃ and ErF₃, and the magnesium silicide-based compound may be one or more selected from the group consisting of MgSiN₂ and Mg₂Si. The rare earth fluoride and the magnesium silicide-based compound have high volatility, and thus may minimize the formation of a secondary phase when being sintered. The presence of the secondary phase may cause phonon scattering which results in the degradation of thermal conductivity. According to at least one embodiment, the formation of a secondary phase may be minimized to reduce phonon scattering which results in the degradation of thermal conductivity, and thus a sintered body with high thermal conductivity may be obtained.

When the silicon nitride powder and the non-oxide-based sintering aid are mixed, the silicon nitride powder may be included at 80 to 99.8 wt %, preferably 90 to 99 wt %, and the non-oxide-based sintering aid may be included at 0.1 to 10 wt %, preferably 0.5 to 5 wt % based on a total weight of the silicon nitride powder and the non-oxide-based sintering aid.

When the non-oxide-based sintering aid is included at less than 0.1 wt %, a sintering process may not be smoothly performed. On the other hand, when the non-oxide-based sintering aid is included at greater than 10 wt %, a liquid amount is increased, and thus mechanical strength, thermal conductivity and the like of a sintered body may be degraded.

According to at least one embodiment, the silicon nitride powder and the non-oxide-based sintering aid are mixed with and dispersed in an organic solvent (e.g., isopropanol) to prepare a slurry. The mixing and dispersing process may be performed at a speed of 125 to 350 rpm at room temperature for 2 to 48 hours.

While being stirred with a magnetic bar to prevent the slurry from precipitating, the slurry is primarily dried at 70 to 150° C. for 0.5 to 2 hours and secondarily dried in a vacuum oven at 80 to 150° C. for 2 to 24 hours to prepare a mixed powder.

Then, the mixed powder is pressurized to form a compact. The compact may be formed under a pressure condition of 100 to 400 MPa. Also, a pressurizing method such as cold isostatic pressing may be used to form a compact having a constant density.

Afterward, the compacts are stacked in layers in a graphite sleeve, the graphite sleeve containing the compacts is placed in a sintering reactor (e.g., graphite furnace), and then the compacts are sintered to manufacture sintered bodies. Through such a sintering process, a pore is minimized and thus a sintered body with a dense structure may be obtained.

According to at least one embodiment, the sintering process of the compact may be performed through hot-press sintering, pressureless sintering, gas pressure sintering, or the like. The hot-press sintering may be performed under a pressure condition of 10 to 50 MPa and a nitrogen atmosphere at 1,700 to 1,800° C. for 1 to 20 hours. A compact may be prevented from being oxidized in the sintering process by maintaining a nitrogen atmosphere during the hot-press sintering.

According to at least one embodiment, the sintered body thus manufactured may be further subjected to a thermally post-treating process at 1,800 to 1,850° C. for 3 to 10 hours. The thermally post-treating process is a purification process for removing defects (e.g., Yb-precipitates, dislocations, or the like) present in a grain or at a grain boundary in the sintered body. Through the thermally post-treating process, the growth of a grain in the sintered body may be suppressed or a formed secondary phase may be removed. Accordingly, phonon scattering which results in the degradation of thermal conductivity is decreased, and thus thermal conductivity of the sintered body may be improved.

### Example 1

Ingredient powders consisting of compositions listed in Table 1 below were added to 100 ml of an isopropanol solvent, and then the mixture was subjected to ball milling using a silicon nitride ball at room temperature at 300 rpm for 24 hours to prepare a slurry.

While being stirred with a magnetic bar to prevent the slurry thus prepared from precipitating, the slurry was primarily dried at 120° C. for 1.5 hours and secondarily dried in a vacuum oven at 60° C. for 1 hour to prepare a mixed powder.

2.0 g of the mixed powder thus prepared was taken, added to a mold, and then subjected to cold isostatic pressing under a pressure condition of 200 MPa to form a discoid compact having a diameter of 20 mm and a thickness of 2.5 mm.

The compacts thus formed were stacked in layers in a graphite sleeve, and graphite spacers were introduced between the compacts to prevent the compacts from being brought into contact with one another. Afterward, the graphite sleeve containing the compacts was placed in a graphite furnace, and the compacts were sintered under a nitrogen atmosphere at 1,800° C. for 2 hours and uniaxially pressurized at a pressure of 25 MPa to manufacture a sintered body.

### Example 2

A sintered body was manufactured in the same manner as Example 1 except that ingredient powders consisting of compositions listed in Table 1 below were used.

### Comparative Example 1

A sintered body was manufactured in the same manner as Example 1 except that ingredient powders consisting of compositions listed in Table 1 below were used.

### Comparative Example 2

A sintered body was manufactured in the same manner as Example 1 except that ingredient powders consisting of compositions listed in Table 1 below were used.

TABLE 1

| | | | Comparative | Comparative |
|---|---|---|---|---|
| Ingredient powder | Example 1 | Example 2 | Example 1 | Example 2 |
| Si₃N₄ powder | 9.2 g | 9.2 g | 9.2 g | 9.2 g |
| (oxygen content: 1.27 wt % and | (92 wt %) | (92 wt %) | (92 wt %) | (92 wt %) |
| average particle diameter: 0.5 to | | | | |
| 0.8 μm) | | | | |
| MgSiN₂ powder | 0.3 g | 0.3 g | — | — |
| (average particle diameter: 3.0 μm) | (3 wt %) | (3 wt %) | | |
| MgO powder | — | — | 0.3 g | 0.3 g |
| (average particle diameter: 1.0 μm) | | | (3 wt %) | (3 wt %) |
| YF₃ | 0.5 g | — | — | — |
| | (5 wt %) | | | |
| YbF₃ | — | 0.5 g | — | — |
| | | (5 wt %) | | |
| Y₂O₃ | — | — | 0.5 g | — |
| | | | (5 wt %) | |
| Yb₂O₃ | — | — | — | 0.5 g |
| | | | | (5 wt %) |

### Experimental Example 1

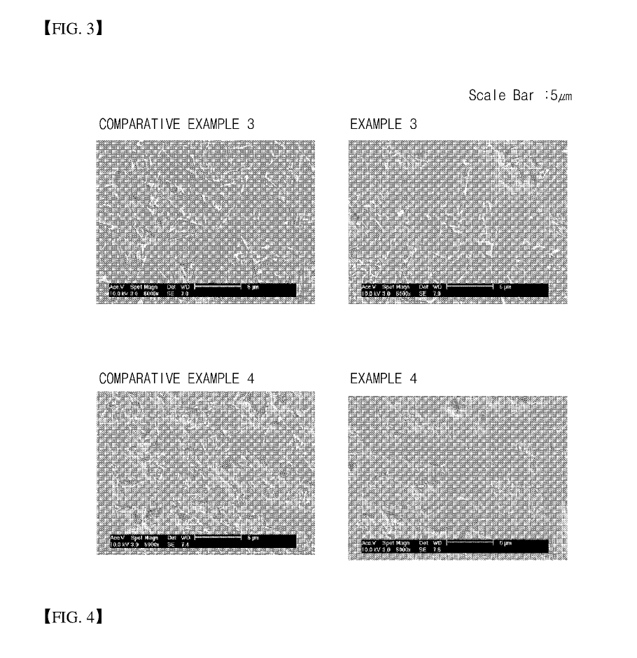

The surface of each sintered body according to Examples 1 and 2 and Comparative Examples 1 and 2 was polished and plasma-etched. Afterward, the microstructure of the sintered body was identified using an electron microscope, the result of which is shown in FIG. 2.

Referring to FIG. 2, it can be confirmed that the sintered bodies according to Examples 1 and 2 exhibited a smaller amount of a secondary phase part (white part) compared to the sintered bodies according to Comparative Examples 1 and 2.

### Experimental Example 2

Thermal conductivity of each sintered body according to Examples 1 and 2 and Comparative Examples 1 and 2 was measured through a laser flash method, the result of which is shown in Table 2 below.

TABLE 2

| | | | Comparative | Comparative |
|---|---|---|---|---|
| Classification | Example 1 | Example 2 | Example 1 | Example 2 |
| Thermal | 58.8 | 62.9 | 55.1 | 53.6 |
| conductivity (k) | | | | |

Referring to Table 2, it can be confirmed that the sintered bodies according to Examples 1 and 2 exhibited higher thermal conductivities compared to the sintered bodies according to Comparative Examples 1 and 2. This is considered to be due to the fact that, as the sintered bodies according to various embodiments have a smaller amount of a secondary phase part, phonon scattering caused by the secondary phase is reduced, and thus thermal conductivity is improved.

### Example 3

Ingredient powders consisting of compositions listed in Table 3 below were added to 100 ml of an isopropanol solvent, and then the mixture was subjected to ball milling using a silicon nitride ball at room temperature at 300 rpm for 24 hours to prepare a slurry.

While being stirred with a magnetic bar to prevent the slurry thus prepared from precipitating, the slurry was primarily dried at 120° C. for 1.5 hours and secondarily dried in a vacuum oven at 60° C. for 1 hour to prepare a mixed powder.

2.0 g of the mixed powder thus prepared was taken, added to a mold, and then subjected to cold isostatic pressing under a pressure condition of 200 MPa to form a discoid compact having a diameter of 20 mm and a thickness of 2.5 mm.

The compacts thus formed were stacked in layers in a graphite sleeve, and graphite spacers were introduced between the compacts to prevent the compacts from being brought into contact with one another. Afterward, the graphite sleeve containing the compacts was placed in a graphite furnace, and the compacts were sintered under a nitrogen atmosphere at 1,750° C. for 2 hours and uniaxially pressurized at a pressure of 25 MPa to manufacture a sintered body.

Then, the sintered body thus manufactured was thermally post-treated at 1,850° C. for 4 hours.

### Example 4

A sintered body was manufactured in the same manner as Example 3 except that ingredient powders consisting of compositions listed in Table 3 below were used.

### Comparative Example 3

A sintered body was manufactured in the same manner as Example 3 except that ingredient powders consisting of compositions listed in Table 3 below were used.

### Comparative Example 4

A sintered body was manufactured in the same manner as Example 3 except that ingredient powders consisting of compositions listed in Table 3 below were used.

TABLE 3

| | | | Comparative | Comparative |
|---|---|---|---|---|
| Ingredient powder | Example 3 | Example 4 | Example 3 | Example 4 |
| Si₃N₄ powder | 9.5 g | 9.5 g | 9.5 g | 9.5 g |
| (oxygen content: 1.27 wt % and | (95 wt %) | (95 wt %) | (95 wt %) | (95 wt %) |
| average particle diameter: 0.5 to 0.8 μm) | | | | |
| MgSiN₂ powder | 0.2 g | 0.2 g | 0.2 g | 0.2 g |
| (average particle diameter: 3.0 μm) | (2 wt %) | (2 wt %) | (2 wt %) | (2 wt %) |
| YF₃ | 0.3 g | — | — | — |
| | (3 wt %) | | | |
| YbF₃ | — | 0.3 g | — | — |
| | | (3 wt %) | | |
| Y₂O₃ | — | — | 0.3 g | — |
| | | | (3 wt %) | |
| Yb₂O₃ | — | — | — | 0.3 g |
| | | | | (3 wt %) |

### Experimental Example 3

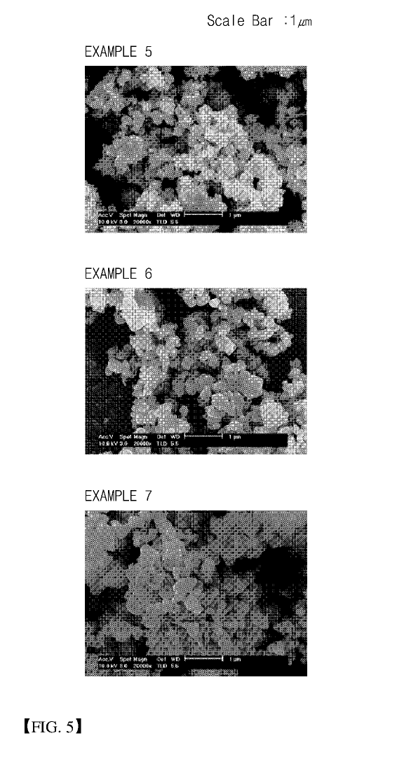

The surface of each sintered body according to Examples 3 and 4 and Comparative Examples 3 and 4 was polished and plasma-etched. Afterward, the microstructure of the sintered body was identified using an electron microscope, the result of which is shown in FIG. 3.

Referring to FIG. 3, it can be confirmed that the sintered bodies according to Examples 3 and 4 exhibited a smaller amount of a secondary phase part (white part) compared to the sintered bodies according to Comparative Examples 3 and 4.

### Experimental Example 4

Thermal conductivity of each sintered body according to Examples 3 and 4 and Comparative Examples 3 and 4 was measured through a laser flash method, the result of which is shown in Table 4 below.

TABLE 4

| | | | Comparative | Comparative |
|---|---|---|---|---|
| Classification | Example 3 | Example 4 | Example 3 | Example 4 |
| Thermal | 79.8 | 84.3 | 71.8 | 75.8 |
| conductivity (k) | | | | |

Referring to Table 4, it can be confirmed that the sintered bodies according to Examples 3 and 4 exhibited higher thermal conductivities compared to the sintered bodies according to Comparative Examples 3 and 4. This is considered to be due to the fact that, as a secondary phase formed during a sintering process is removed through thermal post-treatment, phonon scattering caused by the secondary phase is reduced, and thus thermal conductivity is improved.

### Example 5

Ingredient powders consisting of compositions listed in Table 5 below were added to 100 ml of an isopropanol solvent, and then the mixture was subjected to ball milling using a silicon nitride ball at room temperature at 300 rpm for 24 hours to prepare a slurry.

While being stirred with a magnetic bar to prevent the slurry thus prepared from precipitating, the slurry was primarily dried at 120° C. for 1.5 hours and secondarily dried in a vacuum oven at 60° C. for 1 hour to prepare a mixed powder.

2.0 g of the mixed powder thus prepared was taken, added to a mold, and then subjected to cold isostatic pressing under a pressure condition of 200 MPa to form a discoid compact having a diameter of 20 mm and a thickness of 2.5 mm.

The compacts thus formed were stacked in layers in a graphite sleeve, and graphite spacers were introduced between the compacts to prevent the compacts from being brought into contact with one another. Afterward, the graphite sleeve containing the compacts was placed in a graphite furnace, and the compacts were sintered under a nitrogen atmosphere at 1,750° C. for 2 hours and uniaxially pressurized at a pressure of 25 MPa to manufacture a sintered body.

### Example 6

A sintered body was manufactured in the same manner as Example 5 except that ingredient powders consisting of compositions listed in Table 5 below were used, wherein a Si₃N₄ powder was thermally pretreated under a nitrogen atmosphere at 1,500° C. for 4 hours.

### Example 7

A sintered body was manufactured in the same manner as Example 5 except that ingredient powders consisting of compositions listed in Table 5 below were used, wherein a Si₃N₄ powder was thermally pretreated under a nitrogen atmosphere at 1,500° C. for 10 hours.

TABLE 5

| Ingredient powder | Example 5 | Example 6 | Example 7 |
|---|---|---|---|
| Si₃N₄ powder | 9.5 g | — | — |
| (average particle diameter: 0.5 to | (95 wt %) | | |
| 0.8 μm) | | | |
| Si₃N₄ powder thermally pretreated | — | 9.5 g | — |
| for 4 hours | | (95 wt %) | |
| (average particle diameter: 0.5 to | | | |
| 0.8 μm) | | | |
| Si₃N₄ powder thermally pretreated | — | — | 9.5 g |
| for 10 hours | | | (95 wt %) |
| (average particle diameter: 0.5 to | | | |
| 0.8 μm) | | | |
| MgSiN₂ powder | 0.2 g | 0.2 g | 0.2 g |
| (average particle diameter: 3.0 μm) | (2 wt %) | (2 wt %) | (2 wt %) |
| YbF₃ | 0.3 g | 0.3 g | 0.3 g |
| | (3 wt %) | (3 wt %) | (3 wt %) |

### Experimental Example 5

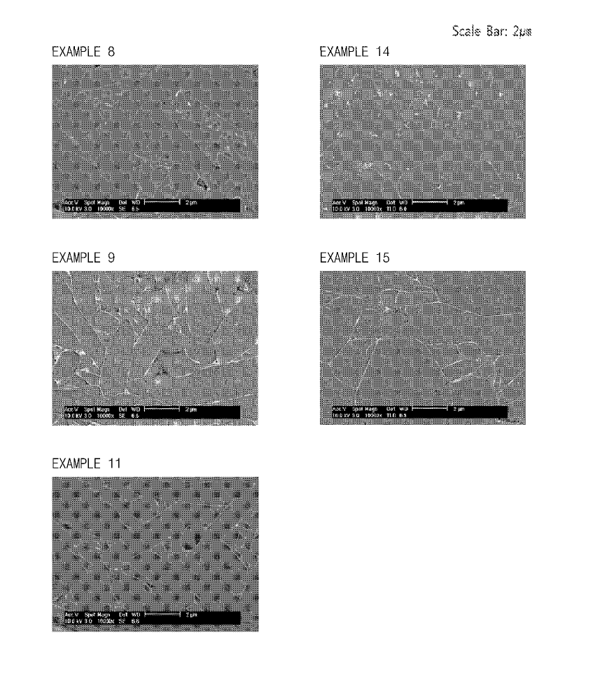

The contents of oxygen and carbon contained in each Si₃N₄ powder used in Examples 5, 6, and 7 were measured through a hot-gas extraction method using inorganic CS/ONH analysis (CS800/ONH-2000, Eltra, Haan, Germany), the result of which is shown in Table 6 below. Also, the microstructure of each Si₃N₄ powder was identified using an electron microscope, the result of which is shown in FIG. 4.

TABLE 5

| Classification | Oxygen content (%) | Carbon content (%) |
|---|---|---|
| Si₃N₄ powder in Example 5 | 1.273 | 0.116 |
| Si₃N₄ powder in Example 6 | 0.979 | 0.106 |
| Si₃N₄ powder in Example 7 | 0.969 | 0.100 |

Referring to Table 6, it can be confirmed that, as a Si₃N₄ powder was thermally pretreated, the contents of oxygen and carbon which are impurities were decreased.

In addition, referring to FIG. 4, it can be confirmed that a grain did not grow even when a Si₃N₄ powder was thermally pretreated for 10 hours to remove oxygen and carbon which are impurities.

### Example 8

The sintered body according to Example 5 was thermally post-treated at 1,830° C. for 3 hours.

### Example 9

The sintered body according to Example 5 was thermally post-treated at 1,830° C. for 7 hours.

### Example 10

The sintered body according to Example 5 was thermally post-treated at 1,830° C. for 10 hours.

### Example 11

The sintered body according to Example 6 was thermally post-treated at 1,830° C. for 3 hours.

### Example 12

The sintered body according to Example 6 was thermally post-treated at 1,830° C. for 7 hours.

### Example 13

The sintered body according to Example 6 was thermally post-treated at 1,830° C. for 10 hours.

### Example 14

The sintered body according to Example 7 was thermally post-treated at 1,830° C. for 3 hours.

### Example 15

The sintered body according to Example 7 was thermally post-treated at 1,830° C. for 7 hours.

### Example 16

The sintered body according to Example 7 was thermally post-treated at 1,830° C. for 10 hours.

### Experimental Example 6

Properties of each sintered body according to Examples 8 to 16 were evaluated, the results of which are shown in Table 7 below. Also, the microstructure of each sintered body was identified using an electron microscope, the result of which is shown in FIG. 5. Here, bending strength was measured using a sample with a size of 3.0×4.0×35 mm through a three-point bending test (crosshead speed: 0.5 mm/min).

TABLE 7

| | Thermal | | | |
|---|---|---|---|---|
| | post- | | Thermal | |
| | treatment | Density | conductivity | Bending strength |
| Classification | time | (g/cm³) | (k) | (MPa) |
| Example 8 | 3 hours | 3.22 | 75.5 | 916.1 |
| Example 9 | 7 hours | 3.21 | 84.4 | 862.1 |
| Example 10 | 10 hours | 3.22 | 96.9 | 792.1 |
| Example 11 | 3 hours | 3.21 | 79.7 | 890.8 |
| Example 12 | 7 hours | — | — | — |
| Example 13 | 10 hours | — | — | — |
| Example 14 | 3 hours | 3.19 | 101.2 | 871.4 |
| Example 15 | 7 hours | 3.2 | 109.9 | 727.8 |
| Example 16 | 10 hours | 3.21 | 120.1 | 699.6 |

Referring to Table 7, it can be confirmed that thermal conductivity of a sintered body was increased to a maximum of 120 W/mK by using a thermally pretreated Si₃N₄ powder and thermally post-treating a sintered body according to various embodiments of the invention. Also, it can be confirmed that a sintered body having a high bending strength ranging from 660 to 870 MPa was manufactured according to the manufacturing method of various embodiments of the invention.

1. A method for manufacturing a silicon nitride sintered body with high thermal conductivity, the method comprising the steps of:
a) obtaining a slurry by mixing a silicon nitride powder and a non-oxide-based sintering aid;
b) obtaining a mixed powder by drying the slurry;
c) forming a compact by pressurizing the mixed powder; and
d) sintering the compact.

2. The method of claim 1, wherein the silicon nitride powder is thermally pretreated at 1,400 to 1,600° C. under a nitrogen or argon atmosphere for 1 to 15 hours.

3. The method of claim 2, wherein the thermally pretreated silicon nitride powder has an oxygen content of less than 1 wt % and an average particle diameter of 0.5 to 0.8 μm.

4. The method of claim 2, wherein the thermally pretreated silicon nitride powder has a carbon content of less than 1 wt %.

5. The method of claim 1, wherein the non-oxide-based sintering aid comprises a rare earth fluoride.

6. The method of claim 5, wherein the rare earth fluoride is one or more selected from the group consisting of YF₃, YbF₃, LaF₃, NdF₃, GdF₃ and ErF₃.

7. The method of claim 5, wherein the non-oxide-based sintering aid further comprises a magnesium silicide-based compound.

8. The method of claim 7, wherein the magnesium silicide-based compound is one or more selected from the group consisting of MgSiN₂ and Mg₂Si.

9. The method of claim 1, wherein the non-oxide-based sintering aid is included at a content of 0.1 to 10 wt % based on a total weight of the silicon nitride powder and the non-oxide-based sintering aid.

10. The method of claim 1, wherein the step of forming the compact is performed by cold isostatic pressing under a pressure condition of 100 to 400 MPa.

11. The method of claim 1, wherein the step of sintering the compact is performed by applying a pressure of 10 to 50 MPa under a nitrogen atmosphere at 1,700 to 1,800° C. for 1 to 20 hours.

12. The method of claim 1, further comprising the step of:
e) thermally post-treating the sintered body at 1,800 to 1,850° C. for 3 to 10 hours.

13. A silicon nitride sintered body with high thermal conductivity manufactured by the method according to claim 1 and has a bending strength of 660 to 870 MPa and a high thermal conductivity of 70 W/mK or more.
